(19) United States
(12) Patent Application Publication
(10) Pub. No.: US 2026/0175606 A1
(43) Pub. Date: Jun. 25, 2026

(54) RECORDING DEVICE

(71) Applicant: SEIKO EPSON CORPORATION, Tokyo (JP)

(72) Inventors: Takeru OGUCHI, CHINO-SHI (JP); Hiroshi SHIOBARA, MATSUMOTO-SHI (JP); Tetsuji YATSUNAMI, OKAYA-SHI (JP)

(21) Appl. No.: 19/428,689

(22) Filed: Dec. 22, 2025

(30) Foreign Application Priority Data
Dec. 25, 2024 (JP) 2024-228851

(51) Int. Cl. B41J 29/38; B41J 2/14; B41J 29/02; B41J 29/13; B41J 29/377

(52) U.S. Cl. CPC B41J 29/38; B41J 2/14; B41J 29/02; B41J 29/13; B41J 29/377; B41J 2002/14491

(57) ABSTRACT

A recording device 10 includes a recording section 18 that records on a medium; a head control section 90 that controls the recording section 18; a frame 101 that is located between the recording section 18 and the head control section 90 and that divides an arrangement region of the recording section 18 from an arrangement region of the head control section 90; and a first cable 111 electrically coupling the recording section 18 and the head control section 90, wherein the head control section 90 is attached to the frame 101, the head control section 90 includes a first board 91 and a second board 92, and the first board 91 and the second board 92 are arranged such that at least part of a face 93 of the first board 91 and of a face 93 of the second board 92 face each other.

The present application is based on, and claims priority from JP Application Serial Number 2024-228851, filed Dec. 25, 2024, the disclosure of which is hereby incorporated by reference herein in its entirety.

### BACKGROUND

### 1. Technical Field

The present disclosure relates to a recording device.

### 2. Related Art

In the related art, various recording devices have been used that include a recording section that performs recording on medium, a head control section that controls the recording section, and a cable that electrically couples the recording section and the head control section. Among these, there is a recording device including a frame that divides an arrangement region of the recording section and an arrangement region of the head control section. For example, JP-A-2016-175282 discloses a recording device comprising a recording head, a control section that controls the recording head, a flat cable that electrically couples the recording head and the control section, and a frame that divides the arrangement region where the recording head is arranged from the arrangement region where the control section is arranged.

The recording device disclosed in JP-A-2016-175282 has a configuration in which the control section is provided in a door that is pivotable with respect to a frame, and the flat cable needs to be routed in the vicinity of a pivot shaft of the door and then routed in the device from the vicinity of the pivot shaft, and thus the flat cable is long. If a cable that electrically couples the recording section and the head control section, such as the flat cable of the recording device in JP-A-2016-175282 is long, noise is likely to occur, and the costs may increase.

### SUMMARY

In order to solve the above problems, a recording device according to the present disclosure includes a recording section that has a head configured to eject liquid and that is configured to record on a medium; a head control section configured to control the recording section; a frame that is located between the recording section and the head control section and that divides an arrangement region of the recording section from an arrangement region of the head control section; and a first cable electrically coupling the recording section and the head control section, wherein the head control section is mounted on the frame, the head control section includes a first board and a second board, and the first board and the second board are arranged such that at least part of a face of the first board and of a face of the second board face each other in a facing direction.

### BRIEF DESCRIPTION OF THE DRAWINGS

FIG. 1 is a perspective view of a recording device according to an embodiment of the present disclosure as viewed from the front side.

FIG. 2 is a schematic diagram illustrating a transport path of medium of the recording device of FIG. 1, as viewed from the front side.

FIG. 3 is a perspective view of the recording device in FIG. 1 as viewed from the back side.

FIG. 4 is a rear view of a control section of the recording device in FIG. 1.

FIG. 5 is a plan view of a control section of the recording device in FIG. 1.

FIG. 6 is a side view of a control section of the recording device in FIG. 1.

FIG. 7 is a front view of a control section of the recording device of FIG. 1.

FIG. 8 is a bottom view of a control section of the recording device in FIG. 1.

FIG. 9 is a rear view of the periphery of a mount region of a control section of the recording device in FIG. 1.

FIG. 10 is a perspective view of a periphery of a back side of a mount region of a control section in a periphery of a frame of the recording device in FIG. 1.

FIG. 11 is a perspective view of the periphery of a mount region of a control section of the recording device of FIG. 1.

FIG. 12 is a perspective view of the periphery of the mount region of the control section of the recording device in FIG. 1, as viewed from an angle different from that in FIG. 11.

FIG. 13 is a side view of the periphery of a mount region of a control section of the recording device in FIG. 1.

FIG. 14 is a rear view of the periphery of a cooling section of the recording device in FIG. 1.

FIG. 15 is a perspective view illustrating an internal configuration of the recording device of FIG. 1.

FIG. 16 is a perspective view illustrating a periphery of an mount region of the medium accommodation cassette of the recording device of FIG. 1.

FIG. 17 is a rear view illustrating a periphery of a mount region of the medium accommodation cassette of the recording device of FIG. 1.

FIG. 18 is a perspective view illustrating a periphery of a sheet holding section of the recording device in FIG. 1.

FIG. 19 is a perspective view illustrating the periphery of the sheet holding section of the recording device in FIG. 1, as viewed from an angle different from that in FIG. 18.

FIG. 20 is a perspective view illustrating the periphery of the sheet holding section of the recording device in FIG. 1, as viewed from an angle different from those in FIGS. 18 and 19.

FIG. 21 is a rear view illustrating a lower section of an ink cartridge of the recording device in FIG. 1.

FIG. 22 is a perspective view of the periphery of the back side of the mount region of the control section in the periphery of the frame of the recording device in FIG. 1, and is a view showing a clamp that holds a tube and a cable.

FIG. 23 is a perspective view illustrating a clamp that holds the tube and the cable in FIG. 22 and illustrating a state in which a cover that covers the tube and the cable is provided.

### DESCRIPTION OF EMBODIMENTS

Hereinafter, the present disclosure will be schematically described.

A recording device according to a first aspect of the present disclosure includes: a recording section that has a head configured to eject liquid and that is configured to record on a medium; a head control section configured to control the recording section; a frame that is located between the recording section and the head control section and that divides an arrangement region of the recording section from an arrangement region of the head control section; and a first cable electrically coupling the recording section and the head control section, wherein the head control section is mounted on the frame, the head control section includes a first board and a second board, and the first board and the second board are arranged such that at least part of a face of the first board and of a face of the second board face each other in a facing direction.

According to the present aspect, the head control section is mounted on the frame. In this way, the head control section is mounted on the frame, and thus it is possible to shorten the cable wiring in the device. Therefore, it is possible to suppress the generation of noise and to suppress an increase in costs.

A recording device according to a second aspect of the present disclosure is an aspect according to the first aspect, wherein the face of the first board and the face of the second board extend in a direction intersecting the frame.

According to present aspect, the face of the first board and the face of the second board extend in a direction intersecting the frame. With such a configuration, both faces of both the first board and the second board are clearly visible, and the user can easily access the substrates.

A recording device according to a third aspect of the present disclosure is an aspect according to the first or second aspect, wherein the first board and the second board are coupled by a board-to-board connector.

According to present aspect, the first board and the second board are coupled with the board-to-board connector. With such a configuration, the first board and the second board can be easily connected to each other, and communication, power supply, and the like can be performed between the first board and the second board. The distance between the first board and the second board can be suppressed, and an increase in the size of the device can be suppressed.

A recording device according to a fourth aspect of the present disclosure is an aspect according to the third aspect, wherein the length, in the facing direction, of an electrical component that is arranged between the first board and the second board and that is mounted on the first board or the second board is smaller than the length of the board-to-board connector in the facing direction.

According to the present aspect, the length of the electrical component disposed between the first board and the second board in the facing direction is smaller than the length of the board-to-board connector in the facing direction. With such a configuration, even when the electrical component is disposed between the first board and the second board, the length between the first board and the second board can be suppressed.

A recording device according to a fifth aspect of the present disclosure is an aspect according to the any one of the first to fourth aspects, wherein the first board has a first region that does not overlap the second board when viewed in the facing direction and a connector is provided in the first region.

According to the present aspect, the first board has the first region that does not overlap the second board when viewed in the facing direction, and the connector is provided in the first region. In this manner, by providing the connector in the region of the first board that does not overlap the second board, the connection of the cable to the connector is facilitated.

A recording device according to a sixth aspect of the present disclosure is an aspect according to the fifth aspect, wherein the first board has the first region at an end section in a first direction, and the first board and the second board are aligned with each other at a position of at least part of end sections in a second direction, which is opposite to the first direction.

According to the present aspect, the first board has the first region at the end section in the first direction, and the positions of at least a part of the end sections of the first board and the second board in the second direction are aligned. With such a configuration, the occupied area by the first board and the second board in the device can be suppressed, and an increase in the size of the device can be suppressed.

A recording device according to a seventh aspect of the present disclosure is an aspect according to the any one of the first to third aspects, wherein the first board has a first region that does not overlap the second board when viewed in the facing direction, the second board includes a second region that does not overlap the first board when viewed in the facing direction, and a connector is provided in the first region of the first board and the second region of the second board.

According to the present aspect, the first board has the first region that does not overlap the second board when viewed in the facing direction, the second board has the second region that does not overlap the first board when viewed in the facing direction, and the connector is provided in the first region and the second region. In this manner, by providing the connector in the region of the first board that does not overlap the second board, the connection of the cable to the connector is facilitated.

A recording device according to a eighth aspect of the present disclosure is an aspect according to the any one of the first to seventh aspects, wherein the first board and the second board each has a first face on which an electrical component is mounted and a second face opposite to the first face, the second face of the first board faces the first face of the second board, the first board has a first region that does not overlap the second board when viewed in the facing direction, and a connector to which the first cable is coupled is provided on the second face of the first region.

According to the present aspect, both the first board and the second board have the first face and the second face on which the electrical components are mounted, the second face of the first board and the first face of the second board face each other, the first board has the first region that does not overlap the second board when viewed in the facing direction, and the connector to which the first cable is coupled is provided on the second face of the first region. With this configuration, the recording section and the first board of the head control section can be connected to each other. Since the connector is provided in the region where the first board and the second board do not overlap (face) each other, it is easy to connect the cable to the connector.

A recording device according to a ninth aspect of the present disclosure is an aspect according to the eighth aspect, wherein the second board includes a second region overlapping the first board when viewed in the facing direction and a connector to which the first cable is coupled is provided on the second face of the second board in the second region.

According to the present aspect, the second board has the second region overlapping the first board when viewed in the facing direction, and the connector to which the first cable is connected is provided on the second face of the second region. With this configuration, the recording section and the second board of the head control section can be connected to each other. Since the connector is provided on the second face of the second board facing the side not facing the first board, even when the connector is provided in the second region of the second board overlapping the first board, the connection of the first cable is facilitated.

A recording device according to a tenth aspect of the present disclosure is an aspect according to the eighth or ninth aspect, wherein the first cable is a flexible flat cable.

According to the present aspect, the first cable is a flexible flat cable. Although information transmission between the recording section and the head control section has a large influence on printing accuracy, the connection of the two sections by the flexible flat cable can increase the resistance to noise. With such a configuration, the first cable can be shortened, and thus, the first cable can increase the resistance to noise.

A recording device according to a eleventh aspect of the present disclosure is an aspect according to the eighth or ninth aspect, wherein the first cable includes a connection board that is connected to the first board and the first board and the connection board are connected by a board-to-board connector.

According to the present aspect, the first cable includes the connection board coupled with the first board, and the first board and the connection board are coupled with each other by the board-to-board connector. With such a configuration, it is possible to improve maintainability.

A recording device according to a twelfth aspect of the present disclosure is an aspect according to the any one of the first to eleventh aspects, further includes a main body control section that controls a device main body and a second cable that electrically couples the head control section and the main body control section, wherein the first board and the second board each has a first face on which an electrical component is mounted and a second face opposite to the first face, the second face of the first board faces the first face of the second board, the second board has a third region that does not overlap the first board when viewed in the facing direction, and a connector to which the second cable is coupled is provided on the first face of the second board in the third region.

According to the aspect, the second face of the first board and the first face of the second board face each other, the second board has the third region that does not overlap the second board when viewed in the facing direction, and the connector to which the second cable electrically connecting the head control section and the main body control section is connected is provided on the first face of the third region. With this configuration, the second board and the main body control section can be connected to each other. By providing the connector in the region of the second board that does not overlap the first board, the second cable is easily connected to the connector.

A recording device according to a thirteenth aspect of the present disclosure is an aspect according to the twelfth aspect, wherein the second cable is a USB communication cable.

According to the present aspect, the second cable is a USB communication cable. Information transmission between the second board and the recording section has a significant influence on the printing accuracy, but communication between the first board and the second board has a smaller influence on the printing accuracy than the influence of the information transmission between the second board and the recording section. Therefore, by connecting the first board and the second board with the USB communication cable, it is possible to suppress the costs without lowering the recording accuracy.

A recording device according to a fourteenth aspect of the present disclosure is an aspect according to the any one of the first to thirteenth aspects, further includes a third cable that supplies power to the head control section, wherein the first board and the second board each has a first face on which an electrical component is mounted and a second face opposite to the first face, the second face of the first board faces the first face of the second board, the second board includes a second region overlapping the first board when viewed in the facing direction, and a connector to which the third cable is coupled is provided on the second face of the second region.

According to the present aspect, the second board has the second region overlapping the first board when viewed in the facing direction, and the connector to which the third cable supplying power to the head control section is connected is provided on the second face of the second region. With such a structure, power can be supplied. Since the connector is provided on the second face of the second board which faces the side not facing the first board, even when the connector is provided in the region overlapping the first board, the third cable is easily connected.

A recording device according to a fifteenth aspect of the present disclosure is an aspect according to the any one of the first to fourteenth aspects, wherein the first board and the second board each has a first face on which an electrical component is mounted and a second face opposite to the first face, the second face of the first board and the second face of the second board face each other.

According to the present aspect, both the first board and the second board have the first face and the second face on which the electrical components are mounted, and the second face of the first board and the second face of the second board face each other. In this way, by causing the first face on which the electrical component is mounted to face the outside in both the first board and the second board, it is possible to suppress an increase in the distance between the first board and the second board.

A recording device according to a sixteenth aspect of the present disclosure is an aspect according to the any one of the first to fifteenth aspects, further includes a board mount section that is mounted to the frame and to which the first board and the second board are mounted, wherein the board mount section is configured to be mounted with a third board in place of the first board.

According to the present aspect, the board mount section that is mounted on the frame and to which the first board and the second board are mounted is provided, and the third board can be mounted on the board mount section instead of the first board. With this configuration, the substrate can be easily replaced.

A recording device according to a seventeenth aspect of the present disclosure is an aspect according to the any one of the first to sixteenth aspects, further includes a cooling section that is attached to the frame and that cools the head control section, wherein the head control section includes a housing section that houses the first board and the second board and the cooling section cools inside the housing section.

According to the present aspect, the cooling section that is attached to the frame and cools the head control section is provided, the head control section includes the housing section that accommodates the first board and the second board, and the cooling section cools the inside of the housing section. With this configuration, the head control section can be cooled. Since the cooling section and the head control section are attached to the same frame, it is possible to improve cooling efficiency compared to a case where the cooling section and the head control section are located at positions separated from each other.

A recording device according to a eighteenth aspect of the present disclosure is an aspect according to the seventeenth aspect, wherein the cooling section includes an intake section, an exhaust section, and a duct configured to guide gas flow between the intake section and the exhaust section, the intake section is located below the housing section, and the exhaust section is located above the housing section.

According to present aspect, in the cooling section, the intake section is located below the housing section, and the exhaust section is located above the housing section. With this configuration, by sucking air from below and exhausting air upward, the gas can be made to flow while also utilizing the upward air flow, and therefore the head control section can be efficiently cooled.

A recording device according to a nineteenth aspect of the present disclosure is an aspect according to the sixth aspect, further includes a cooling section that is attached to the frame and that cools the head control section, wherein the head control section includes a housing section that houses the first board and the second board and the cooling section includes an intake section, an exhaust section, and a duct configured to cause gas flow from the intake section to the exhaust section via the housing section, and the duct causes the gas to flow into the housing section from an end section of the housing section in the second direction and the gas to flow out from an end section of the housing section in the first direction.

According to the present aspect, the duct of the cooling section causes the gas to flow into the housing section from the end section of the housing section in the second direction and causes the gas to flow out from the end section of the housing section in the first direction. With such a configuration, by causing the gas to flow in from the second direction in which the first board and the second board are aligned, these boards can be cooled more effectively.

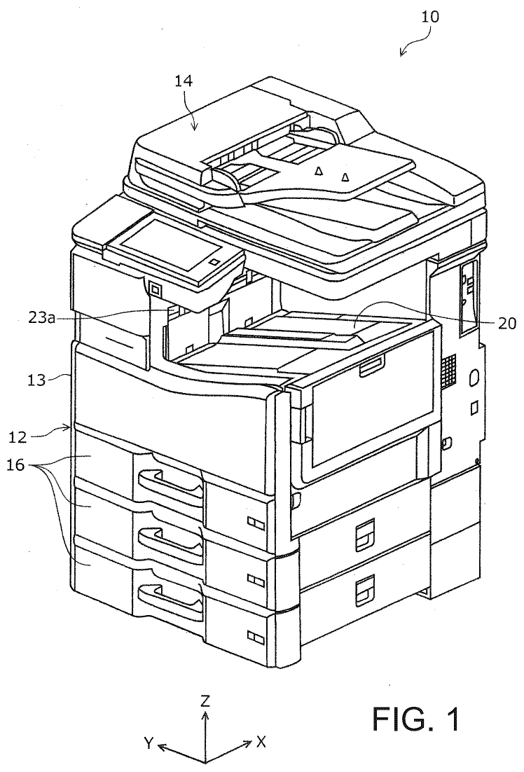

The present disclosure will be described in detail below. First, an outline of a recording device according to an embodiment of the disclosure will be described with reference to FIGS. 1 to 3. An inkjet printer 10 (hereinafter, simply referred to as a printer 10 in some cases) is exemplified as an example of a recording device of the present embodiment. Note that in an X-Y-Z coordinate system illustrated in each drawing, an X-axis direction indicates a width direction of medium P in a transport path in the recording device, a Y-axis direction indicates a length direction of the medium P on which recording is performed by a recording section described below, and a Z-axis direction indicates an apparatus height direction.

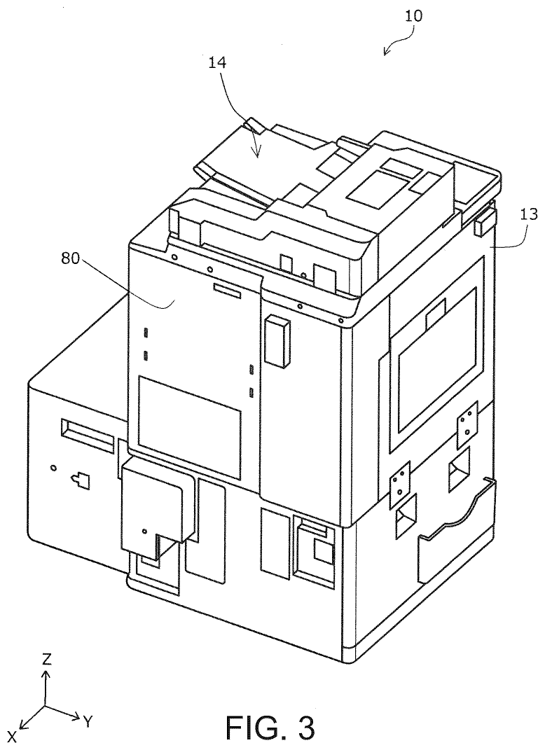

As illustrated in FIGS. 1 and 3, the printer 10 is configured as a multifunction device including an device main body 12 and a scanner unit 14. The device main body 12 includes a plurality of medium accommodation cassettes 16 that accommodate the medium P. Each medium accommodation cassette 16 is detachably attached from the −X axis direction side, which is the front side of the device main body 12. Note that in the present specification, the medium P refers to, for example, a paper sheet such as a plain paper, a cardboard, or a photo paper.

In the device height direction in the device main body 12, recording is performed in a recording section 18 between the scanner unit 14 and the medium accommodation cassette 16. After recording, the medium P is discharged from an outlet 23a of a discharge section 23. A medium placement section 20 that receives the medium P discharged from the outlet 23a is also provided.

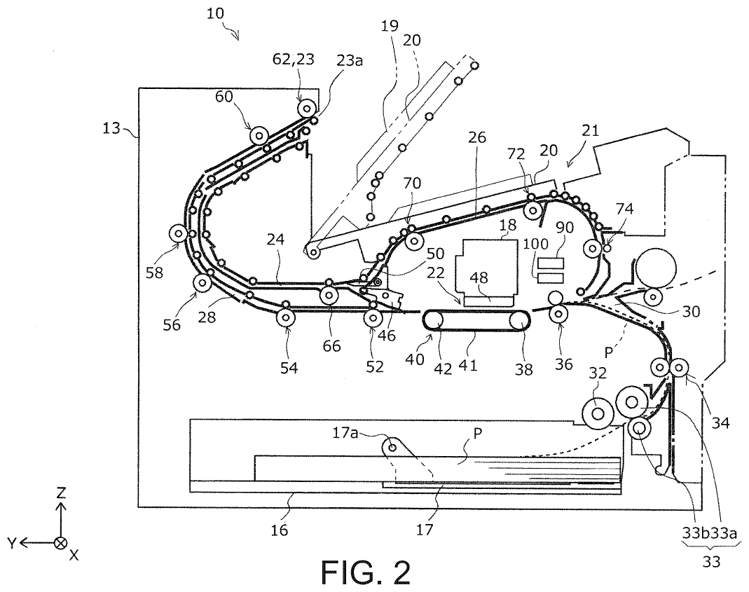

As illustrated in FIG. 2, the printer 10 includes a medium transport path 21 inside a housing 13. The medium transport path 21 includes a straight path 22, a face down discharge path 28, and a feed path 30 connected from the medium accommodation cassette 16 to the straight path 22. Further, the medium transport path 21 includes a switchback path 24 and a inversion path 26, and is configured to be capable of so-called double-sided recording in which recording is performed on a second face after recording is performed on a first face of the medium P. Note that as illustrated in FIG. 3, a detachable lid section 80 is provided on the +X direction side of the housing 13 of the printer 10.

A feed roller 32, a separation roller pair 33, and a transport roller pair 34 are provided in the feed path 30 in order along the transport direction of the medium P. The feed roller 32 is rotary driven by a driving source (not shown). The separation roller pair 33 separates the medium P by nipping the medium P between a transport drive roller 33a and a driven roller 33b.

The transport roller pair 34 is configured by a drive roller and a driven roller. Each transport drive roller is controlled by a main body control section 100 provided in the device main body 12 via a driving source (not illustrated). Although details will be described later, the printer 10 includes a head control section 90 that controls a line head 48, and the head control section 90 is attached to a frame 101 provided on the −X direction side of the lid section 80 illustrated in FIG. 3. In the printer 10 of the embodiment, the main body control section 100 and the head control section 90 are configured to be able to execute control necessary for the recording operation.

In the following description, one roller of each transport roller pair appearing in the specification is configured as a driven roller, and the other roller is configured as a drive roller that is rotary driven by a driving source (not illustrated). In the present embodiment, unless otherwise specified, one roller is configured as a spur having a plurality of teeth on the outer periphery thereof, and the drive roller, which is the other roller, is configured as a rubber roller, for example.

The medium P accommodated in the medium accommodation cassette 16 is supported on a hopper 17 provided in the medium accommodation cassette 16. The hopper 17 pivots about a pivot shaft 17a provided in the hopper 17, and lifts the medium P upward. At this time, the feed roller 32 comes into contact with the uppermost sheet of medium P of the medium P supported by the hopper 17 and transports the medium P to the downstream side in the transport direction. At this time, there is a case where the next and subsequent sheets of medium P are transported together with the uppermost positioned sheet of medium P, but the uppermost positioned sheet of medium P and the next and subsequent sheets of medium P are separated from each other by the separation roller pair 33, and only the uppermost positioned sheet of medium P is transported to the downstream side in the transport direction.

A transport roller pair 36 is provided on the downstream of the transport roller pair 34 in the transport direction. In the present embodiment, the feed path 30 and the straight path 22 are coupled at the position of the transport roller pair 36. That is, the feed path 30 is set as a path from the medium accommodation cassette 16 to the transport roller pair 36.

The straight path 22 is configured as a path extending linearly, and is provided with the transport roller pair 36, a transport mechanism 40, the recording section 18, and a first flap 46 in this order along the transport direction. The transport mechanism 40 is configured from a drive roller 38, a driven roller 42, and an endless belt 41. Note that in the present embodiment, the straight path 22 is set as a path from the transport roller pair 36 to the first flap 46.

The recording section 18 includes the line head 48. The transport mechanism 40 is provided below the line head 48. In the present embodiment, the line head 48 is configured to perform recording by ejecting ink onto the recording face of the medium P when the medium P is transported to a position facing the line head 48 on the transport mechanism 40. The line head 48 is a recording head in which nozzles that eject ink are provided so as to cover the entire width of the medium P, and is configured as a recording head that can perform recording on the entire width of the medium without moving in the medium width direction. The printer 10 of the present embodiment includes the line head 48, but may include a serial type recording head that is mounted on a carriage and performs recording by ejecting liquid onto a medium while reciprocating in a direction intersecting the medium transport direction.

The transport mechanism 40 including the drive roller 38, the driven roller 42, and the endless belt 41 is provided at a position facing the line head 48. The first flap 46 is located downstream of the transport direction. The first flap 46 is configured to be switchable by a drive mechanism (not shown) so as to connect the straight path 22 and the switchback path 24 or connect the straight path 22 and the face down discharge path 28.

A second flap 50 is provided above the first flap 46 in the device height direction (Z-axis direction). The second flap 50 is driven by an interlocking mechanism (not shown) in conjunction with the operation of the first flap 46. The first flap 46 and the second flap 50 change their postures under the control of the main body control section 100.

The face down discharge path 28 curves and inverts while extending upward from the straight path 22 in the device height direction. The face down discharge path 28 includes a transport roller pair 52, a transport roller pair 54, a transport roller pair 56, a transport roller pair 58, a transport roller pair 60, and a transport roller pair 62 constituting the discharge section 23. The face down discharge path 28 is a path from the first flap 46 to the outlet 23a located downstream of the transport roller pair 62 in the transport direction. That is, the face down discharge path 28 is the medium transport path 21 coupled with the straight path 22, and is a path for inverting the recording face of the medium P passing through the recording section 18 between the recording section 18 and the discharge section 23 and sending the medium P to the discharge section 23.

The medium P on which recording is executed on the recording face by the recording section 18 is sequentially nipped in the face down discharge path 28 by the transport roller pair 52, the transport roller pair 54, the transport roller pair 56, the transport roller pair 58, the transport roller pair 60, and the transport roller pair 62 in this order from the first flap 46 along the transport direction, and is transported through the face down discharge path 28. Then, the medium P is discharged from the outlet 23a toward the medium placement section 20.

The inversion path 26 is a path for inverting the medium P, and includes a transport roller pair 70, a transport roller pair 72, and a transport roller pair 74. The medium P that has passed once through the straight path 22, which is the medium transport path 21 that faces the recording section 18, passes through the inversion path 26, whereby the surface facing the recording section 18 is inverted, and the medium P passes again through the straight path 22, which is the medium transport path 21 that faces the recording section 18. The medium P passes through the inversion path 26, and thus recording can be performed on both faces of the medium P.

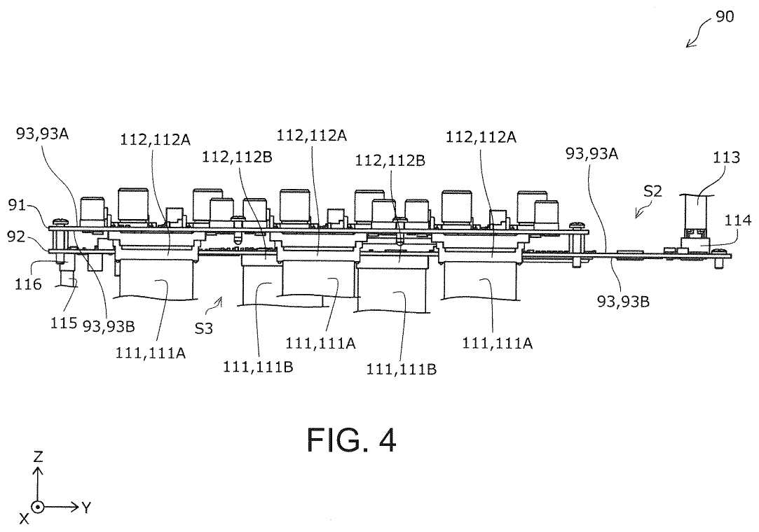

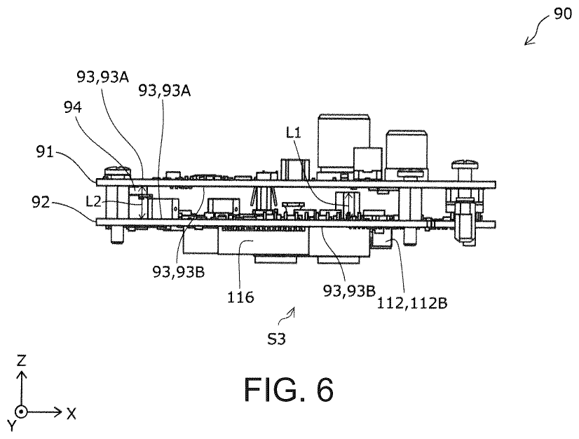

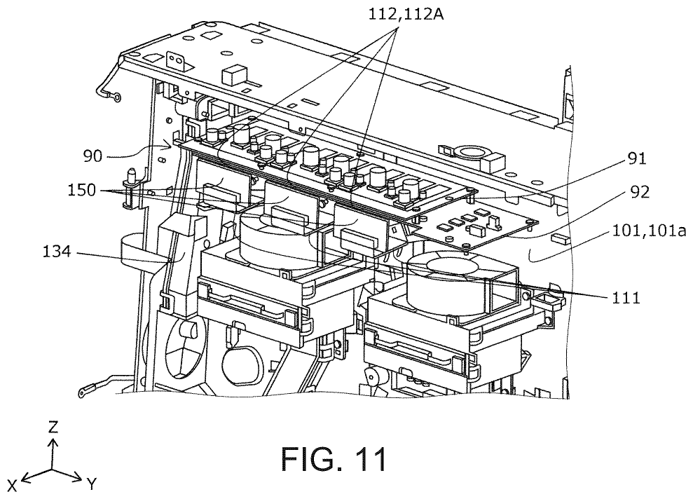

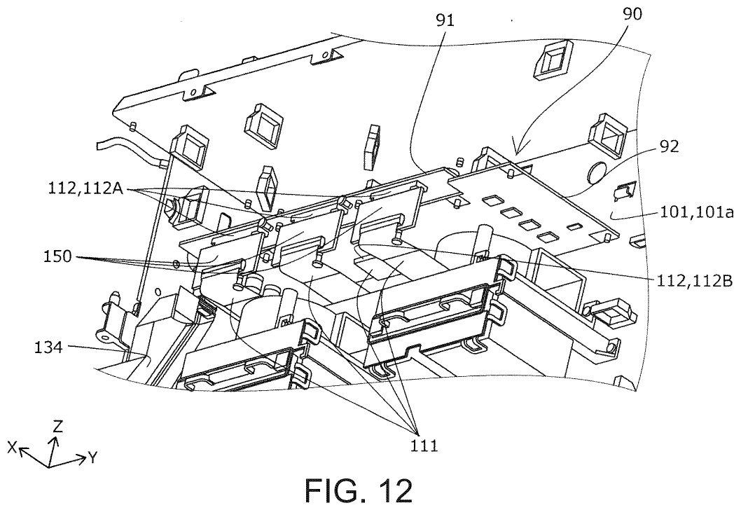

Here, a specific configuration of the head control section 90, which is a main section of the printer 10 of the present embodiment, will be described with reference to FIGS. 4 to 14. As described above, the printer 10 of the present embodiment includes the recording section 18, which that includes the line head 48 for ejecting liquid ink and that performs recording on the medium P, and the head control section 90 that controls the recording section 18.

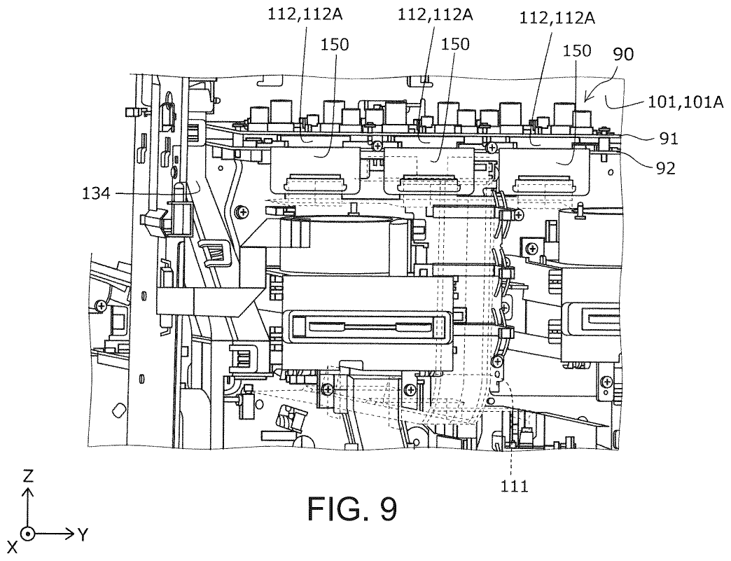

Here, the printer 10 of the present embodiment includes the frame 101 as illustrated in FIGS. 9 to 14. The frame 101 is located between the recording section 18 and the head control section 90 in the X-axis direction, and partitions the arrangement region of the recording section 18 and the arrangement region of the head control section 90. To be specific, a face 101a of the frame 101 on the +X direction is a face to which the head control section 90 is attached, and a face 101b of the frame 101 is a face on the −X direction opposite to the face 101a and is a face facing the recording section 18.

As illustrated in FIG. 4, the printer 10 of the present embodiment includes a head communication FFC 111 as a first cable. The head communication FFC 111 electrically connects the recording section 18 and the head control section 90. Since the head control section 90 is mounted on the frame 101, as shown in FIGS. 9 to 12, it is not necessary to route the flat cable (head communication FFC) near the pivot shaft of the door and then further into the device from that vicinity of the pivot shaft. Therefore, the cable wiring in the device can be shortened.

Here, as illustrated in FIGS. 4 to 8, the head control section 90 includes a head drive board 91 as a first board and a head main board 92 as a second board. Note that the first board and the second board are not particularly limited, and the head drive board 91 can be regarded as the second board and the head main board 92 can be regarded as the first board. As illustrated in FIGS. 4 to 8, the head drive board 91 and the head main board 92 are positioned facing each other, with their respective faces 93 aligned in the facing direction, which corresponds to the Z-axis direction.

As in the printer 10 of the present embodiment, the head control section 90 is attached to the frame 101, and thus it is possible to shorten the cable wiring in the device. Therefore, it is possible to suppress the generation of noise and to suppress an increase in costs. As in the printer 10 of the present embodiment, it is desirable that the head control section 90 has the first board and the second board and that the first board and the second board are configured such that at least a part of the face of the first board and the face of the second board face each other in the facing direction. This is because the occupied area by the head control section 90 can be suppressed by configuring the head control section 90 with a plurality of boards and overlapping the boards in this manner. Furthermore, by configuring the head control section 90 with a plurality of boards, partial replacement of the head control section 90 is simplified, for example, only the first board can be replaced.

In the printer 10 of the present embodiment, as illustrated in FIG. 9 and FIGS. 11 to 14, a face 93 of the head drive board 91 and the face 93 of the head main board 92 extend in the horizontal direction (the plane direction extending in the X-axis direction and the Y-axis direction), which is a direction intersecting the frame 101. With such a configuration, both faces of both the first board and the second board are clearly visible, and the user can easily access the substrates. Note that in the present embodiment, the first board and the second board are laid out to extend in the horizontal direction (direction intersecting the frame 101), but the present disclosure is not limited to such a configuration. The first board and the second board may be laid out to extend in the vertical direction (direction along the frame).

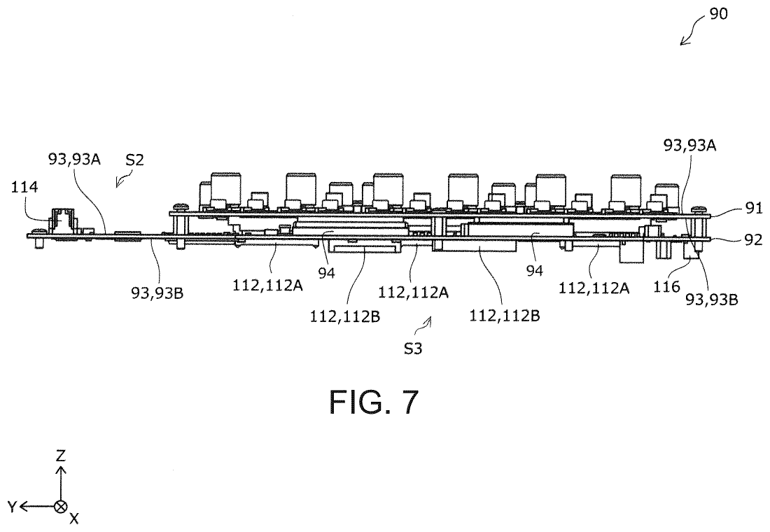

In the printer 10 of the embodiment, as illustrated in FIG. 7, the head drive board 91 and the head main board 92 are coupled to each other by a board-to-board connector 94. With such a configuration, the first board and the second board can be easily connected to each other, and communication, power supply, and the like can be performed between the first board and the second board. The distance between the first board and the second board can be suppressed, and an increase in the size of the device can be suppressed.

In the printer 10 of the embodiment, as illustrated in FIG. 7, each electrical component of the head main board 92 provided in the region facing the head drive board 91 is provided in a gap between the head drive board 91 and the head main board 92, which are connected to each other via the board-to-board connector 94 in the Z-axis direction. In other words, in the printer 10 of the embodiment, the length (for example, L1) in the Z-axis direction of an electrical component that is arranged between the first board and the second board and that is mounted on the first board or on the second board is smaller than the length L2 in the Z axis direction of the board-to-board connector 94. Note that the length L2 of the board-to-board connector 94 in the Z-axis direction can be rephrased as the distance between the head drive board 91 and the head main board 92. With such a configuration, even when the electrical component is arranged between the first board and the second board, the length between the first board and the second board in the facing direction can be suppressed. Note that examples of the electrical components include a capacitor, a memory, a system on chip (SOC) and the like.

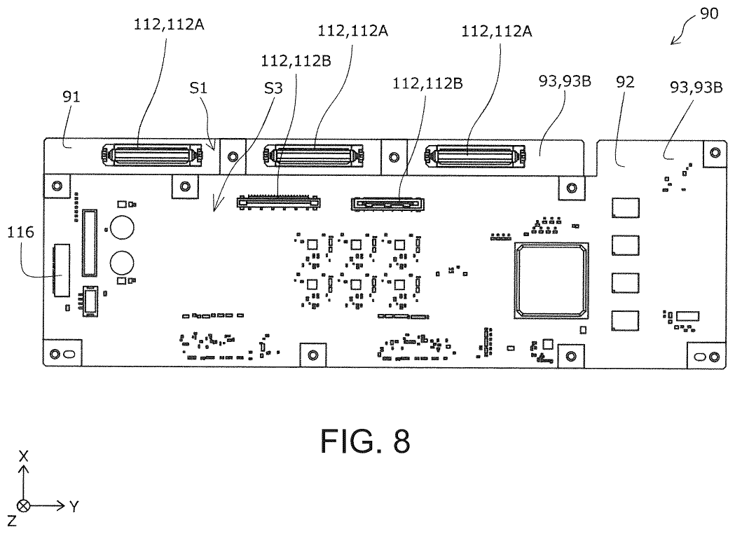

In present embodiment of the printer 10, as shown in FIG. 8, the head drive board 91 has a region S1 that does not overlap with the head main board 92 when viewed along the Z-axis. In this region S1, a head communication FFC connector 112A, which serves as the connector for the cable (head communication FFC 111) connected to the recording section 18, is provided. When the head drive board 91 is regarded as a first board and the head main board 92 is regarded as a second board, it can be expressed that the first board has a first region that does not overlap the second board when viewed in the facing direction and that the connector is provided in the first region.

On the other hand, in the printer 10 of the present embodiment, as illustrated in FIGS. 4, 5, and 7, the head main board 92 has a region S2 that does not overlap the head drive board 91 when viewed in the Z axis direction, and a USB communication cable connector 114, which is a connector of a USB communication cable 113 connected to the main body control section 100, is provided in the region S2. When the head main board 92 is regarded as a first board and the head drive board 91 is regarded as a second board, it can be expressed that the first board has a first region that does not overlap the second board when viewed in the facing direction and that the connector is provided in the first region.

In this manner, by providing the connector in the region of the first board that does not overlap the second board, the connection of the cable to the connector is facilitated. Note that there is no particular limitation on the cable connected to the connector in the region of the first board that does not overlap the second board. A cable different from the cable of the present embodiment may be connected. Another connector may be provided in a region other than the region of the first board that does not overlap the second board. Furthermore, the connector may be provided on either of the faces 93 of the first board or the second board.

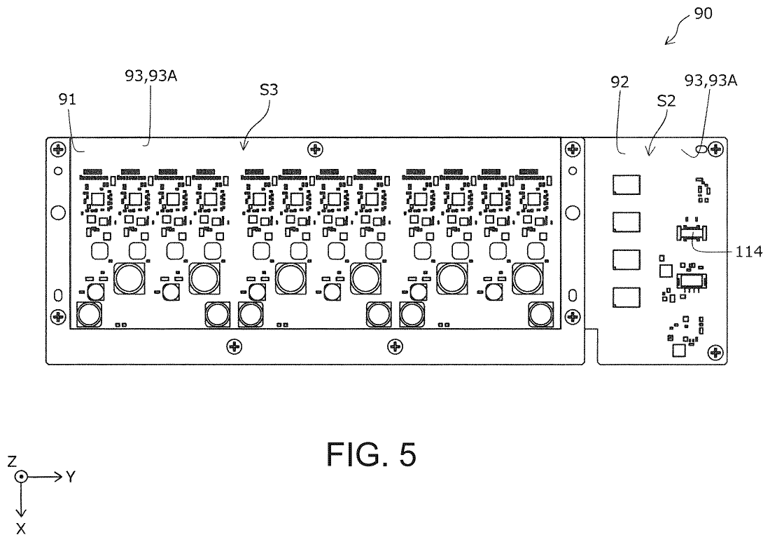

In other words, in the printer 10 of the embodiment, the first board has a first region (for example, the region S1 and the region S2) that does not overlap the second board when viewed in the Z-axis direction, the second board has a second region (the region S3 illustrated in FIGS. 5 and 8) that does not overlap the first board when viewed in the Z-axis direction, and the connector is provided in at least one of the first region and the second region. In this manner, by providing the connector in the region of the first board that does not overlap the second board, the connection of the cable to the connector is facilitated.

In other words, in the printer 10 of the embodiment, the first board has a first region (for example, the region S1 and the region S2) that does not overlap the second board when viewed in the Z-axis direction, the second board has a second region (the region S3 illustrated in FIGS. 5 and 8) that does not overlap the first board when viewed in the Z-axis direction, and the connector is provided in the first region and the second region. In this manner, by providing the connector in the region of the first board that does not overlap the second board, the connection of the cable to the connector is facilitated.

In the printer 10 of the embodiment, as illustrated in FIGS. 4, 5, 7, and 8, the positions of the head drive board 91 and the head main board 92 in the −Y direction are aligned. In other words, in the printer 10 of the embodiment, the head main board 92 as the first board has the region S2 as the first region at the end portion in the first direction, which corresponds to the +Y direction, and the positions of the end sections of the head drive board 91 and the head main board 92 in the second direction, which corresponds to the −Y direction, are aligned. In this manner, by adopting a configuration in which the first board has the first region at the end section in the first direction and the positions of at least a part of the end sections of the first board and the second board in the second direction are aligned, it is possible to suppress the occupied area of the first board and the second board in the device and to suppress an increase in the size of the device. Note that in the present embodiment, the positions of the end portions are aligned in the −Y direction, but a configuration in which the positions of the end sections are aligned in the +Y direction, a configuration in which the positions of the end sections are aligned in the X-axis direction, or the like may be adopted. It is desirable that the positions of the entire sides of the end sections in the second direction are aligned, but a configuration in which the positions of a part of the end sections in the second direction are aligned may be adopted.

Note that as illustrated in FIGS. 4 to 8, the head drive board 91 and the head main board 92 both have, as the face 93, the first face 93A on which the electrical components are mounted and the second face 93B which is a surface opposite to the first face 93A. Here, the second face 93B of the head drive board 91 and the first face 93A of the head main board 92 face each other. When the head drive board 91 is regarded as the first board and the head main board 92 as the second board, as shown in FIG. 8, the head drive board 91, serving as the first board, has a first region (region S1) that does not overlap with the head main board 92 when viewed along the Z-axis. On the second face 93B of this region S1, the head communication FFC connector 112A is provided, to which a head communication FFC 111A, serving as the first cable, is connected. By configuring the printer 10 of the present embodiment in this manner, the recording section 18 and the first board (the head drive board 91) of the head control section 90 can be connected. By providing the connector (head communication FFC connector 112A) in the region S1 where the first board and the second board do not overlap (face) each other, it is easy to connect the cable to the connector.

Furthermore, in the printer 10 of this embodiment, as shown in FIGS. 5 and 8, the second board (head main board 92) has a second region (region S3) that overlaps with the first board (head drive board 91) when viewed along the Z-axis direction. On the second face 93B of region S3, a connector (head communication FFC connector 112B) is provided to which a head communication FFC 111B, serving as the first cable, is connected. By adopting such a configuration, the printer 10 of the present embodiment can connect the recording section 18 and the second board (the head main board 92) of the head control section 90. In the second board (head main board 92), since the connector (head communication FFC connector 112B) is provided on the second face 93B facing the side not facing the first board (head drive board 91), even when the connector (head communication FFC connector 112B) is provided on the region S3 of the second board overlapping the first board, the connection of the first cable (head communication FFC 111B) is easy.

In the printer 10 of the embodiment, the head communication FFC 111A and the head communication FFC 111B, which are the head communication FFC 111 as the first cable, are both flexible flat cables. Although information transmission between the recording section 18 and the head control section 90 has a large influence on printing accuracy, the connection of the two sections by a flexible flat cable can increase the resistance to noise. With such a configuration, the first cable can be shortened, and thus, the first cable can increase the resistance to noise.

In the printer 10 of the embodiment, as illustrated in FIGS. 9, 11, and 12, when the head main board 92 is regarded as the first board, the head communication FFC 111A as the first cable includes a connection circuit board 150 connected to the head main board 92 as the first board. The head main board 92 and the connection circuit board 150 are coupled to each other by the head communication FFC connector 112A, which is also a board-to-board connector.

In this manner, by adopting a configuration in which the first cable includes the connection board connected to the first board, and the first board and the connection board are connected to each other by the board-to-board connector, it is possible to improve maintainability. It is possible to avoid obliquely inserting a cable such as an FFC. This is particularly effective when the connector is provided on a downward face.

As described above, the printer 10 of the present embodiment includes the main body control section 100 that controls the device main body, and the USB communication cable 113 as the second cable that electrically connects the head control section 90 and the main body control section 100. As illustrated in FIGS. 4 and 7, the USB communication cable connector 114 is provided in the region S2 of the head main board 92. In other words, both the head drive board 91 and the head main board 92 have the first face 93A on which the electrical components are mounted and the second face 93B, which is a face opposite to the first face 93A, and the second face 93B of the head drive board 91 and the first face 93A of the head main board 92 face each other. The head main board 92 has a region S2 as a third region that does not overlap the head drive board 91 when viewed in the Z-axis direction, and a connector (USB communication cable connector 114) to which the USB communication cable 113 is connected is provided on the first face 93A of the region S2. With this configuration, the second board and the main body control section 100 can be connected to each other. By providing the connector in the region of the second board that does not overlap the first board, the second cable is easily connected to the connector. Note that a connector may be provided in a region of the second board that overlaps the first board.

Here, information transmission between the second board and the recording section 18 has a large influence on printing accuracy, but communication between the first board and the second board has a small influence on printing accuracy. Therefore, the second cable is the USB communication cable 113, which is low in cost, and the first board and the second board are coupled by the USB communication cable 113, so that costs can be suppressed without lowering the recording accuracy.

Further, as illustrated in FIG. 4, the printer 10 of the embodiment includes a power cable 115 as a third cable that supplies power to the head control section 90. As illustrated in FIGS. 4 and 8, a power cable connector 116 to which the power cable 115 is connected is provided on the second face 93B of the region S3 of the head main board 92. The printer 10 of the present embodiment can supply power by having such a configuration. In the head main board 92, since the power cable connector 116 is provided on the second face 93B facing the side not facing the head drive board 91, even in a configuration in which the power cable connector 116 is provided in the region overlapping the head drive board 91, the connection of the power cable 115 is easy.

Here, as illustrated in FIGS. 4 to 8, the printer 10 of the present embodiment has a configuration in which the second face 93B of the head drive board 91 and the first face 93A of the head main board 92 face each other in the region S3. In other words, the first face 93A of the first board on which the electrical components are mounted and the second face 93B of the second board face each other. However, the present disclosure is not limited to such a configuration. That is, both the first board and the second board may have a first face 93A on which the electrical components are mounted and a second face 93B that is a face opposite to the first face 93A, and the second face 93B of the first board and the second face 93B of the second board may face each other. Thus, by oppositely arranging the first faces 93A, on which electrical components are mounted, so that they face outward on both the first board and the second board, it is possible to suppress an increase in the distance between the first board and the second board. Note that although the face on which the main electrical components are mounted is referred to as the first face 93A, electrical components may be mounted on the second face. In this case, the face on which the component having a large height is mounted can be regarded as the first face. A face on which a large number of electrical components are mounted may be regarded as the first face. The face on which the electrical components that perform main roles are mounted may be regarded as the first face.

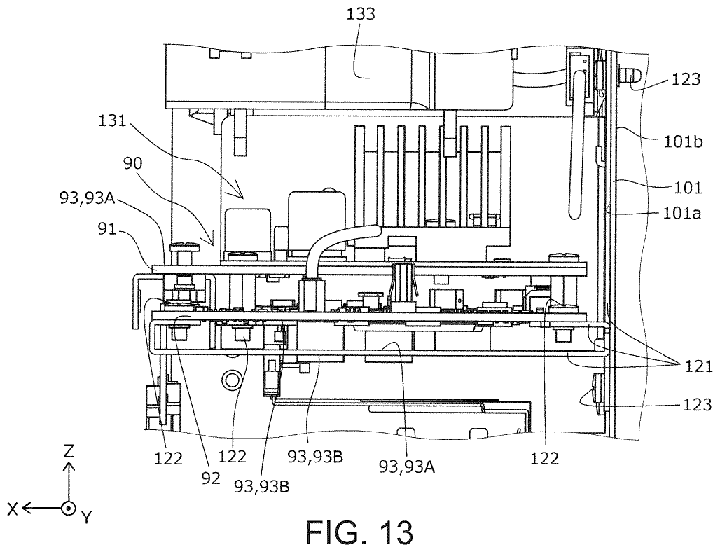

As illustrated in FIG. 13, the printer 10 of the embodiment includes a board-mounting metal bracket 121 as a board mount section that is attached to the frame 101 and to which the head drive board 91 and the head main board 92, as the first board and the second board, are attached. Then, the board-mounting metal bracket 121 can be configured to mount a new head drive board 91 and a new head main board 92, serving as third boards, in place of the originally installed the head drive board 91 and the head main board 92. For example, in a case where the first board is the head drive board 91, the control of the line head 48 can be changed by replacing the head drive board 91. With such a configuration, the number of new components can be reduced. The printer 10 of the present embodiment is configured as described above, and thus, the board is easily replaced. Note that it is necessary that the replaceable board is provided with a connector to which the same cable as that of the board before replacement can be connected. In this case, the third board may be a board on which the electrical components are mounted, the electrical components being different from those on the first board and the second board.

Note that as illustrated in FIG. 13, the head drive board 91 and the head main board 92 as the first board and the second board are fixed to the board-mounting metal bracket 121 with a screw 122. The board-mounting metal bracket 121 is fixed to the frame 101 with a screw 123. However, there is no particular limitation on the method of fixing the first board and the second board to the frame 101.

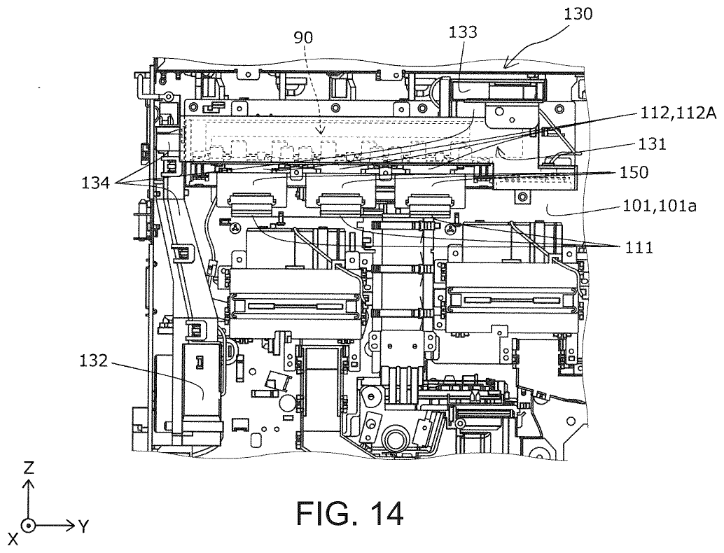

Further, as illustrated in FIG. 14, the printer 10 of the present embodiment includes a cooling section 130 that is attached to the frame 101 and that cools the head control section 90. The head control section 90 includes a housing section 131 that houses the head drive board 91 and the head main board 92. Note that the housing section 131 may not completely surround the head drive board 91 and the head main board 92. The cooling section 130 is configured to be capable of cooling the inside of the housing section 131. The printer 10 of the present embodiment can cool the head control section 90 by having such a configuration. Since the cooling section 130 and the head control section 90 are attached to the same frame 101, the cooling efficiency can be improved as compared with a case where the cooling section 130 and the head control section 90 are located at positions separated from each other.

Specifically, as illustrated in FIG. 14, the cooling section 130 includes an intake section 132, an exhaust section 133, and a duct 134 that causes gas to flow between the intake section 132 and the exhaust section 133. The intake section 132 is located below the housing section 131, and the exhaust section 133 is located above the housing section 131. The printer 10 of the embodiment has such a configuration, and by sucking air from below and exhausting air upward, the gas can be made to flow while also using the upward air current due to the warmed gas, and therefore the head control section 90 can be efficiently cooled.

To describe the above from another viewpoint, the duct 134 is configured to cause the gas to flow into the housing section 131 from the end section of the housing section 131 in the second direction corresponding to the −Y direction and cause the gas to flow out from the end section of the housing section 131 in the first direction corresponding to the +Y direction, as illustrated in FIG. 14. That is, the inflow port is located on the second direction side of the housing section 131, and the outflow port is located on the first direction side of the housing section 131. In the present embodiment, the printer 10 is configured as described above, and by allowing gas to flow in from the second direction in which the first board and the second board are aligned, these boards can be cooled more effectively. That is, in such a configuration, the distance between the inflow port through which the cold gas flows in and the first board and the second board can be shortened, and these substrates can be cooled more effectively. Note that the faces of the housing 13 on which the inflow port and the outflow port are provided are not limited to the side faces, and may be the top face or the bottom face.

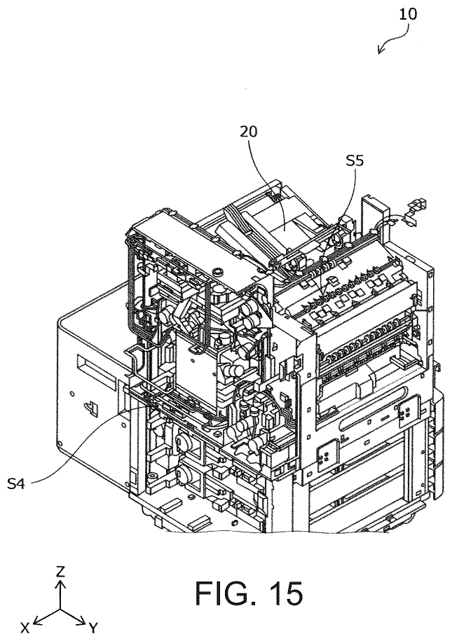

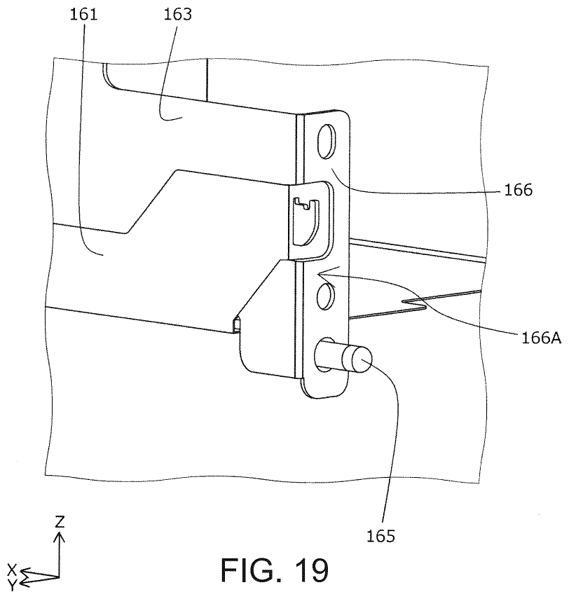

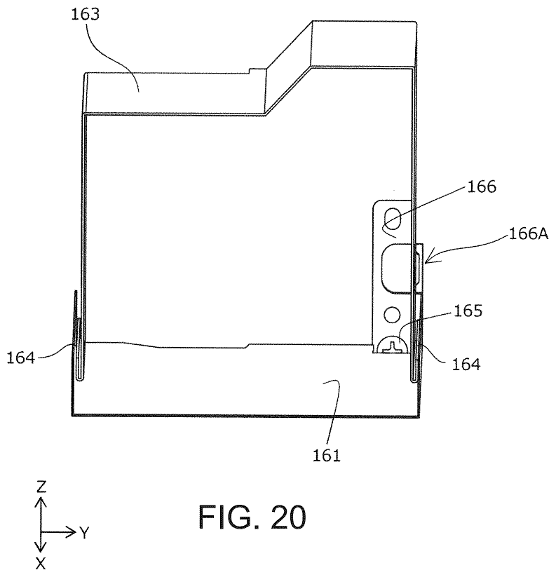

Further, hereinafter, with reference to FIGS. 15 to 23, a description will be given of features different from the head control section 90 related to the printer 10 of the present embodiment. The printer 10 of present embodiment includes the medium accommodation cassette 16 and a plurality of harnesses 151 in the region S4 in FIG. 15. The medium accommodation cassette 16 is configured such that a leg section 16A is movable in the region S4 along the X-axis direction, but if the medium accommodation cassette 16 and the harnesses 151 are close to each other, there is a concern that the medium accommodation cassette 16 and the harnesses 151 may catch when the medium accommodation cassette 16 is moved.

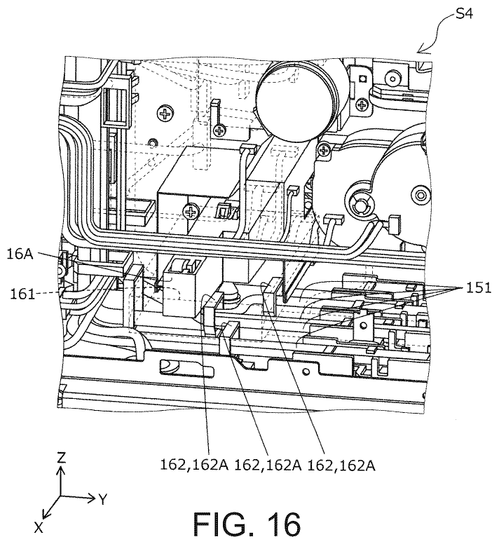

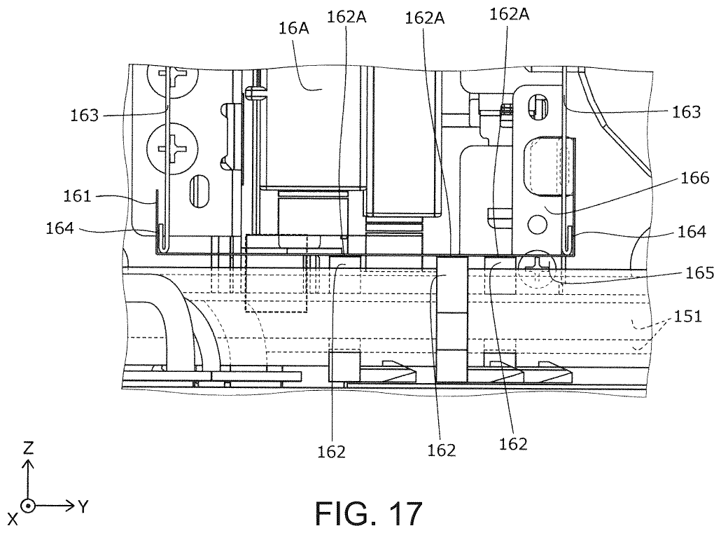

Therefore, as illustrated in FIGS. 16 and 17, the printer 10 of the present embodiment includes a sheet member 161 made of polyethylene terephthalate (PET) so that the medium accommodation cassette 16 and the harness 151, which is a cable or the like, do not catch when the medium accommodation cassette 16 is moved. The sheet member 161 is attached to a fixing metal bracket 163 with double-sided tape 164, and is fastened to a rear metal bracket 166 together with the fixing metal bracket 163 with one screw 165. The sheet member 161 is held in contact with the plurality of clamps 162 in the Z-axis direction. The harness 151 is located below a top face section 162A of a clamp 162.

Specifically, the sheet member 161 is fixed in a stretched state on the lower face side of the top face section 162A of the plurality of clamps 162. Therefore, the sheet member 161 and the harness 151 do not protrude above the top face section 162A of the clamp 162 in the upper side. Therefore, the medium accommodation cassette 16 and the sheet member 161 do not interfere with each other.

Since the sheet member 161 is clamped between the screw 165 used for co-tightening, the fixing metal bracket 163, the rear metal bracket 166, and the clamp 162, the sheet member 161 does not move inside the printer 10 even if the double-sided tape 164 becomes detached. Note that the sheet member 161 is preferably formed of a transparent member. This is because such a configuration enables the wiring state to be visible without removing the sheet member 161.

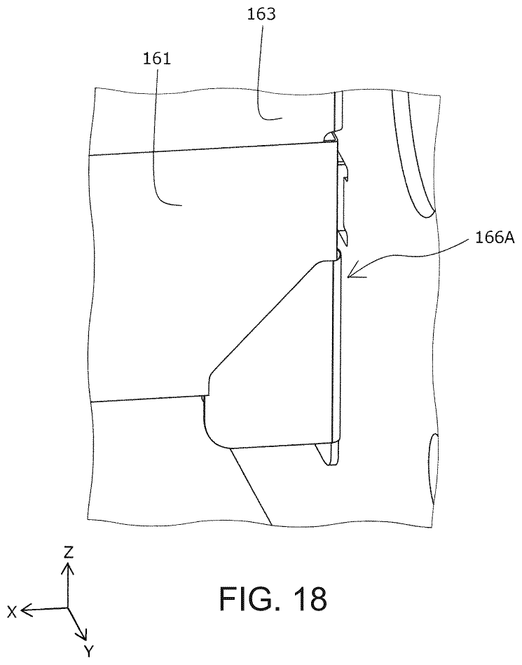

In a co-fastening method using the screw 165, as illustrated in FIGS. 18 to 20, a relief and hook shape 166A are formed in the rear metal bracket 166 to prevent the sheet member 161 from being clamped at an unintended location. As a result, the torque of the screw 165 is not loosened by the deformation of the sheet member 161. That is, the printer 10 of the present embodiment is provided with a shape for pressing the harness 151 by the sheet member 161 made of PET, and is devised to secure necessary rigidity by bending both ends of a thin material while pressing the harness 151 in a space-saving manner.

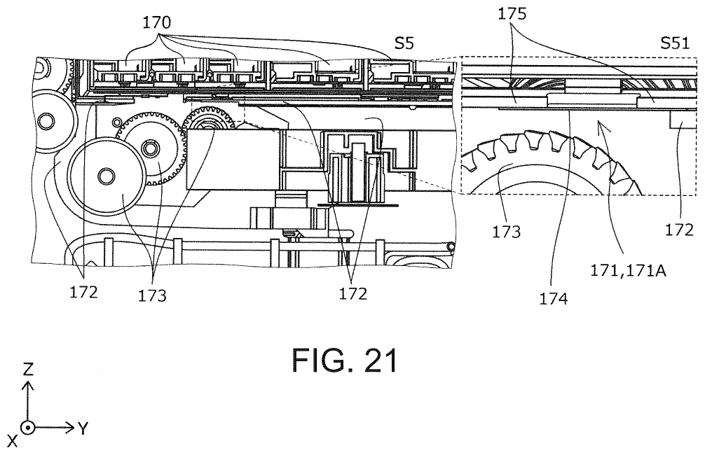

In the printer 10 of the present embodiment, a unit having an ink cartridge 170 can be attached to the region S5 of FIG. 15. Then, in the region S5, specifically in a region S51 as illustrated in FIG. 21, a hole section 171A is formed in a lower section 171 of the flow path of the ink cartridge 170. Since the hole section 171A is formed, a unit having the ink cartridge 170 can be screwed to the region S5. Note that although a motor (not shown), the gears 173, and the like are provided in the region S5, ink may leak from the hole section 171A to the gears 173 and the like because the hole section 171A is formed. If an absorbent member 172 is disposed so as to cover the hole section 171A in the lower section 171 of the flow path of the ink cartridge 170, ink leakage can be suppressed. However, since the hole section 171A is located close to the gear 173 in the Z-axis direction and the absorbent member 172 is thick, it is difficult to dispose the absorbent member 172 in a position that covers the hole section 171A near the gear 173.

Therefore, in the printer 10 of the present embodiment, as illustrated in FIG. 21, a thin sheet 174 made of PET is attached to the hole section 171A instead of the absorbent member 172. In the printer 10 of the present embodiment, the sheet 174 is attached to a metal bracket 175, but the method of attaching the sheet 174 is not particularly limited. That is, in the printer 10 of the present embodiment, the absorbent member 172 is disposed so as to avoid the motor, the gears 173, and the like, and the thin sheet 174 made of PET is attached to the hole section 171A so as to prevent the ink from leaking. The absorbent member 172 is disposed outside the sheet 174 to absorb ink accumulated on the hole section 171A.

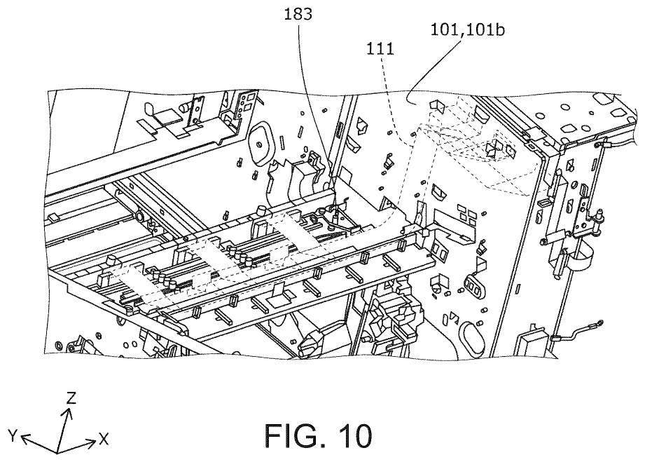

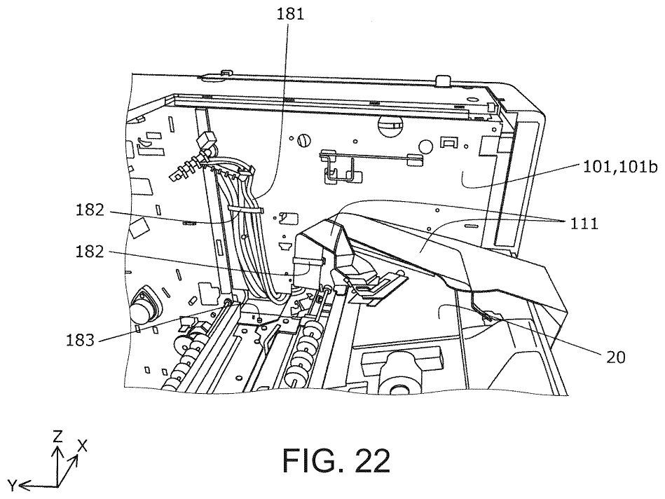

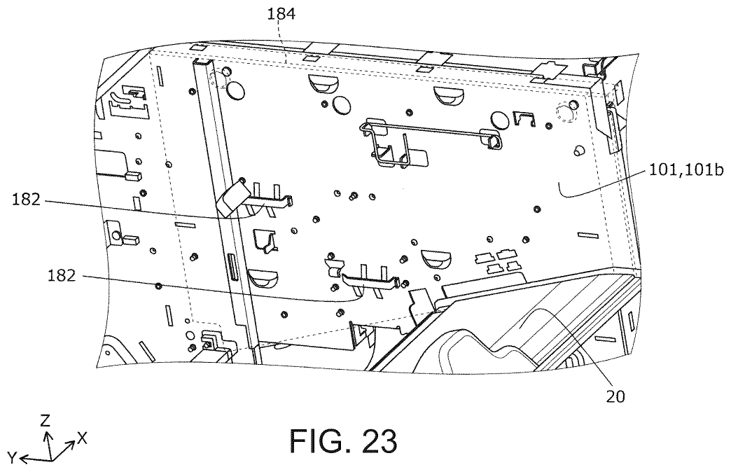

When the line head 48 is replaced, a tube 181, which is a flow path of the ink, or the head communication FFC 111 may be an obstacle. As illustrated in FIG. 22, the tube 181 and the head communication FFC 111, both of which are connected to the line head 48, are disposed on the face 101b side of the frame 101. For example, when the line head 48 is replaced, the tube 181 or the head communication FFC 111 may be an obstacle, and it may be difficult to access a screw 183 illustrated in FIGS. 10 and 22. Therefore, as illustrated in FIGS. 22 and 23, the printer 10 of the present embodiment includes a plurality of fixing clamps 182 that temporarily hold the tube 181 or the head communication FFC 111. Note that in FIG. 22, the line head 48 is detached, and thus the head communication FFC 111 is detached from a connector (not illustrated) on the line head 48 side.

The printer 10 of the present embodiment includes a cover section 184 that covers the face 101b side of the frame 101. The cover section 184 covers the face 101b side of the frame 101 except when the line head 48 is replaced, and is hidden by various exterior components on the face 101b side of the frame 101. Then, the cover section 184 is removed when the line head 48 is replaced, but the work for using the fixing clamp 182 does not increase. That is, the printer 10 of the present embodiment has a configuration in which the line head 48 can be easily replaced.

The present disclosure is not limited to the embodiments described above, and various modifications are possible within the scope of the disclosure described in the claims, and it is needless to say that they are also included in the scope of the present disclosure.

What is claimed is:

1. A recording device comprising:
a recording section that has a head configured to eject liquid and that is configured to record on a medium;
a head control section configured to control the recording section;
a frame
that is located between the recording section and the head control section and
that divides an arrangement region of the recording section from an arrangement region of the head control section; and
a first cable electrically coupling the recording section and the head control section, wherein
the head control section is mounted on the frame,
the head control section includes a first board and a second board, and
the first board and the second board are arranged such that at least part of a face of the first board and of a face of the second board face each other in a facing direction.

2. The recording device according to claim 1, wherein
the face of the first board and the face of the second board extend in a direction intersecting the frame.

3. The recording device according to claim 1, wherein
the first board and the second board are coupled by a board-to-board connector.

4. The recording device according to claim 3, wherein
the length, in the facing direction, of an electrical component that is arranged between the first board and the second board and that is mounted on the first board or the second board is smaller than the length of the board-to-board connector in the facing direction.

5. The recording device according to claim 1, wherein
the first board has a first region that does not overlap the second board when viewed in the facing direction and
a connector is provided in the first region.

6. The recording device according to claim 5, wherein
the first board has the first region at an end section along the first board in a first direction, and
the first board and the second board are aligned with each other at a position of at least part of end sections in a second direction, which is opposite to the first direction.

7. The recording device according to claim 1, wherein
the first board has a first region that does not overlap the second board when viewed in the facing direction,
the second board includes a second region that does not overlap the first board when viewed in the facing direction, and
a connector is provided in the first region of the first board and the second region of the second board.

8. The recording device according to claim 1, wherein
the first board and the second board each has a first face on which an electrical component is mounted and a second face opposite to the first face,
the second face of the first board faces the first face of the second board,
the first board has a first region that does not overlap the second board when viewed in the facing direction, and
a connector to which the first cable is coupled is provided on the second face of the first region.

9. The recording device according to claim 8, wherein
the second board includes a second region overlapping the first board when viewed in the facing direction and
a connector to which the first cable is coupled is provided on the second face of the second board in the second region.

10. The recording device according to claim 8, wherein
the first cable is a flexible flat cable.

11. The recording device according to claim 8, wherein
the first cable includes a connection board that is connected to the first board and
the first board and the connection board are connected by a board-to-board connector.

12. The recording device according to claim 1, further comprising:
a main body control section that controls a device main body and
a second cable that electrically couples the head control section and the main body control section, wherein
the first board and the second board each has a first face on which an electrical component is mounted and a second face opposite to the first face,
the second face of the first board faces the first face of the second board,
the second board has a third region that does not overlap the first board when viewed in the facing direction, and
a connector to which the second cable is coupled is provided on the first face of the second board in the third region.

13. The recording device according to claim 12, wherein
the second cable is a USB communication cable.

14. The recording device according to claim 1, further comprising:
a third cable that supplies power to the head control section, wherein
the first board and the second board each has a first face on which an electrical component is mounted and a second face opposite to the first face,
the second face of the first board faces the first face of the second board,
the second board includes a second region overlapping the first board when viewed in the facing direction, and
a connector to which the third cable is coupled is provided on the second face of the second region.

15. The recording device according to claim 1, wherein
the first board and the second board each has a first face on which an electrical component is mounted and a second face opposite to the first face and
the second face of the first board and the second face of the second board face each other.

16. The recording device according to claim 1, further comprising:
a board mount section that is mounted to the frame and to which the first board and the second board are mounted, wherein
the board mount section is configured to be mounted with a third board in place of the first board.

17. The recording device according to claim 1, further comprising:
a cooling section that is attached to the frame and that cools the head control section, wherein
the head control section includes a housing section that houses the first board and the second board and
the cooling section cools inside the housing section.

18. The recording device according to claim 17, wherein
the cooling section includes
an intake section,
an exhaust section, and
a duct configured to guide gas flow between the intake section and the exhaust section,
the intake section is located below the housing section, and
the exhaust section is located above the housing section.

19. The recording device according to claim 6, further comprising:
a cooling section that is attached to the frame and that cools the head control section, wherein
the head control section includes a housing section that houses the first board and the second board,
the cooling section includes
an intake section,
an exhaust section, and
a duct configured to cause gas flow from the intake section to the exhaust section via the housing section, and
the duct causes
the gas to flow into the housing section from an end section of the housing section in the second direction and
the gas to flow out from an end section of the housing section in the first direction.
